(19) United States
(12) Patent Application Publication
(10) Pub. No.: US 2014/0364090 A1
(43) Pub. Date: Dec. 11, 2014

(54) GATEWAY FOR VOICE COMMUNICATION

(71) Applicant: DYL, LLC, Marina del Rey, CA (US)

(72) Inventor: Michael Kritikos Frager, Marina del Rey, CA (US)

(21) Appl. No.: 13/911,058

(22) Filed: Jun. 5, 2013

(51) Int. Cl. H04W 4/12; H04W 8/22

(52) U.S. Cl. CPC H04W 4/12; H04W 8/22
USPC 455/413; 455/414.1; 455/552.1

(57) ABSTRACT

A process receives a text based request from a first communication device to communicate with a second communication device associated with a subscription identifier based upon a subscription service. The text based request includes the subscriber identifier. Further, the process determines an endpoint identifier associated with the subscription identifier based upon the subscription identifier. In addition, the process establishes voice communication between the first communication device and the second communication device associated with the subscription identifier.

### BACKGROUND

1. Field

This disclosure generally relates to the field of communication networks for communication devices. More particularly, the disclosure relates to communication networks for voice communication devices.

2. General Background

Current telephone networks allow users to communicate via various communication devices such as telephones. The public switched telephone network (“PSTN”) is a network of various cables, satellites, and the like that are interconnected via switching centers. A particular telephone has a telephone number associated with it so that a different telephone can call that telephone number to establish communication.

Various mobile telephone devices have been developed for utilization with PSTN networks. A standard mobile telephone is referred to as a feature telephone. The feature telephone provides basic functionality such as the ability to connect to a PSTN network for a telephone call with another user and the ability to send Short Message Service (“SMS”) text messages. In contrast, a smartphone provides such functionality in addition to other enhancements such as computing and connectivity that are similar to that of a standard computer. For example, a smartphone may connect to the Internet, browse webpages, download applications, and the like. A feature telephone typically does not provide such functionality.

Similar to many other computing devices, a smartphone also allows a user to connect to a voice over internet protocol (“VoIP”) network. Users may connect to a VoIP network via a smartphone or another type of computing device through a VoIP software application for voice communication that is provided via the Internet or another network rather than a typical PSTN network. A feature telephone typically does not have a VoIP software application. Therefore, a feature telephone is typically unable to access a VoIP network. As a result, a feature telephone is often limited in the types of voice communications that may be available to a smartphone.

### SUMMARY

In one aspect of the disclosure, a process is provided. The process receives a text based request from a first communication device to communicate with a second communication device associated with a subscription identifier based upon a subscription service. The text based request includes the subscriber identifier. Further, the process determines an endpoint identifier associated with the subscription identifier based upon the subscription identifier. In addition, the process establishes voice communication between the first communication device and the second communication device associated with the subscription identifier.

In another aspect of the disclosure, a computer program product includes a computer useable medium having a computer readable program. The computer readable program when executed on a computer causes the computer to receive a text based request from a first communication device to communicate with a second communication device associated with a subscription identifier based upon a subscription service. The text based request includes the subscriber identifier. Further, the computer readable program when executed on the computer causes the computer to determine an endpoint identifier associated with the subscription identifier based upon the subscription identifier. In addition, the computer readable program when executed on the computer causes the computer to establish voice communication between the first communication device and the second communication device associated with the subscription identifier.

In yet another aspect of the disclosure, an apparatus is provided. The apparatus comprises a computing device that receives a text based request from a first communication device to communicate with a second communication device associated with a subscription identifier based upon a subscription service, determines an endpoint identifier associated with the subscription identifier based upon the subscription identifier, establishes voice communication between the first communication device and the second communication device associated with the subscription identifier. The text based request includes the subscriber identifier.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a gateway configuration that is utilized to establish voice communication in response to a text based request.

FIG. 2 illustrates the components of the gateway server illustrated in FIG. 1.

FIG. 3 illustrates a process that may be utilized to establish the voice communication provided for in FIG. 1.

FIG. 4 illustrates a block diagram of a station or system that performs routing to establish voice communication as provided for in FIG. 1.

### DETAILED DESCRIPTION

A method, system, apparatus, and computer program product may be utilized to provide a gateway for connecting and establishing a voice communication between a user that may or may not be a subscriber of a communication network and a user that is a subscriber of a communication network. The gateway may be a computing device such as a server device, computing platform, or the like.

A communications network may be established so that a subscription service is utilized to access the communications network. A subscriber to the communications network establishes a subscription by providing a subscriber identifier and an endpoint identifier. The term endpoint identifier is intended herein to mean an identifier at which communication may be established, e.g., a telephone number, a digital address, or the like. The communications network may then route future communications to that subscriber based upon the subscriber identifier and the endpoint identifier.

As an example, a first subscriber may select an e-mail address as a subscriber identifier and a telephone number as an endpoint identifier. A second subscriber may provide the e-mail address rather than the telephone number of the first subscriber to a communication device to establish communication with the first subscriber. As a result, the second subscriber may utilize the e-mail address of the first subscriber for multiple purposes, e.g., calling the first subscriber, e-mailing the first subscriber, or the like, without having to remember or store both an e-mail address and a telephone number. A variety of other types of identifiers may be utilized instead of an e-mail address, e.g., a social networking username, a uniform resource locator (“URL”), a hashtag topic identifier, or the like.

If both users are subscribers and have smartphones or other types of mobile computing devices, e.g., tablet devices, such connectivity is possible. In contrast, such connectivity may not be feasible if both users do not have smartphones or other types of mobile computing devices. For example, a first user may have a smartphone and may be a subscriber to a communications network. As a subscriber, the first user may associate his or her e-mail address with an endpoint identifier such as his or her smartphone telephone number. Accordingly, a second user that is a subscriber and that has a smartphone or other type of mobile computing device may establish a voice communication with the first user by providing the subscriber identifier as an input. The subscriber network then determines the associated telephone number of the first user and then routes the voice communication to the first user. If the second user is not a subscriber of the subscriber network, the second user may be able to install an application that allows the second user to establish a voice communication with the subscriber via the subscriber identifier. As a result, the first user may provide the subscriber identifier to the second user for voice communication, e-mail communication, or the like rather than having to provide multiple identifiers for various methods of communication. If the second user has a feature phone rather than a smartphone, the second user will typically not be able to utilize the subscriber identifier for communication with the first user because the feature phone typically will not have a VoIP software application. Further, the second user may have a smartphone and may be unable to utilize the subscriber identifier of the first user if the second user has not registered with the subscription service or has not downloaded a VoIP software application that allows for communication with the first user via the subscriber identifier of the first user.

The gateway allows for communication with the first user via the subscriber identifier whether or not the second user has a smartphone or a feature telephone. Further, the gateway allows for communication with the first user via the subscriber identifier whether or not the second user is or is not a subscriber of the subscriber network.

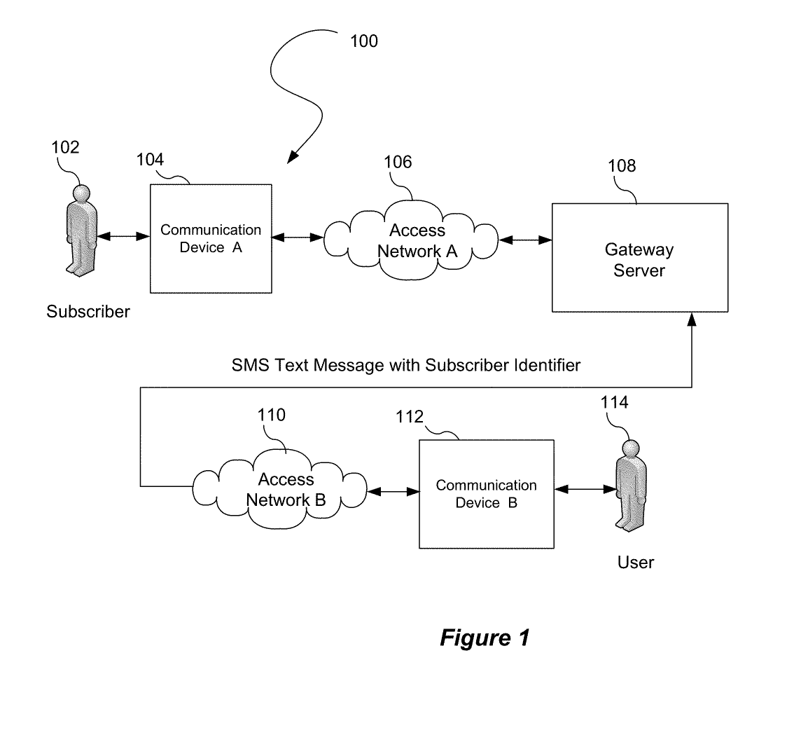

FIG. 1 illustrates a gateway configuration 100 that is utilized to establish voice communication in response to a text based request. A subscriber 102 subscribes to a subscription service, which allows the subscriber 102 to associate a subscriber identifier such as an e-mail address with an endpoint identifier such as a telephone number. The subscriber 102 may then provide the subscriber identifier to a user 114 so that the user 114 may utilize the subscriber identifier rather than the endpoint identifier to establish voice communication with the subscriber 102. In one embodiment, the user 114 is not a subscriber to the subscription service to which the subscriber 102 is a subscriber. The user 114 may be a subscriber to a different subscription service or not be a subscriber to a subscription service. The subscriber 102 communicates with a communication device A 104, which is a mobile computing device such as a smartphone, tablet device, or the like. In one embodiment, the communication device A 104 is capable of connecting with a VoIP network. The VoIP network transmits and receives voice signals as data packets. A variety of other types of networks may be utilized for similar or different types of communications.

The user 114 communicates with a communication device B 112. In one embodiment, the communication device B 112 is a mobile computing device without the capability of connecting to a VoIP network. For example, the communication device B 112 may be a feature phone. In another embodiment, the communication device B 112 has the capability of connecting to a VoIP network. For example, the communication device B 112 may be a smartphone. In such instance, the user 114 is unable to have a voice communication via the subscriber identifier because the user 114 has not registered with a subscription service, downloaded a VoIP application, or the like. Accordingly, the user 114 may be unable to have a voice communication via the subscriber identifier with the subscriber 102 for a variety of reasons.

A communication device is herein intended to include any electronic device that is capable of exchanging voice, video, and/or text data with another electronic device through a communications network. Examples of communication devices include, but are not limited to, digital telephones, smartphones, cellular phones, personal computers, laptops, notebooks, tablet devices, and/or the like. The communication devices may communicate through access networks with the gateway server 108. The access networks may include various types of connections to a carrier, e.g., telephone service provider. Examples of such connections include wireless, cable, satellite, PSTN, or the like. The access network A 106 provides communication between the communication device A 104 and the gateway server 108. Further, the access network B 110 provides communication between the communication device B 112 and the gateway server 106.

As the communication device B 112 is unable to communicate with the communication device A 104 via the subscriber identifier, the communication device B 112 sends a text based request, e.g., via an SMS text message, to the gateway server 108. The communication device communication device B 112 may utilize an SMS short code that identifies the gateway server 108. For example, the communication device B 112 may send a text message to the SMS short code RINGML or 746465. This example is provided simply for illustrative purposes as a variety of short codes may be utilized. Further, other messaging protocols other than SMS may alternatively be utilized.

The text based request includes the subscriber identifier of the subscriber A 102, e.g., an e-mail address for the subscriber A 102. In one embodiment, the gateway server 108 determines if the subscriber identifier is valid. If the subscriber identifier is valid, the gateway server 108 may then initiate a connection mode. Various possible implementations may be utilized for the connection mode to establish a voice communication between the subscriber A 102 and the user 114. In one embodiment, the connection mode comprises the gateway server 108 sending a voice communication to the user 114. For example, the voice communication may be a reply telephone call to the user 114. After the user answers the reply telephone call, the gateway server 108 may then automatically connect the user 114 to the subscriber A 102. The gateway server 108 determines the endpoint identifier from the associated subscriber identifier and establishes a voice communication between the subscriber 102 and the user 114 via a PSTN network. For example, the user 114 may be immediately connected to an outbound call directed to the subscriber's destination. The connection mode is performed without the user 114 having to know the endpoint identifier associated with the subscriber identifier.

In an alternative embodiment, the reply telephone call does not automatically establish a voice communication between the subscriber 102 and the user 114. The gateway server 108 may send a prompt to the user 114. For example, the gateway server 108 may request that the user 114 press a particular numeral prior to the gateway server 108 establishing the voice communication between the subscriber 102 and the user 114. As a result, the gateway server 108 is able to confirm that the user 114 is a human rather than an automated system attempting to call the subscriber 102.

In yet another alternative embodiment, the gateway server 108 has an automated voicemail detection system that is utilized to determine if the user 114 is a human or a voicemail answering machine. If the gateway server 108 determines that the user 114 is a human, then the voice communication between the subscriber 102 and the user 114 is established. If the gateway server 108 determines that the user 114 is a voicemail, the gateway server 108 hangs up the telephone call and does not establish a voice communication between the subscriber 102 and the user 114. In one embodiment, the gateway server 108 does not leave a voicemail message.

In one embodiment, the gateway server 108 establishes the voice communication between the subscriber 102 and the user 114 based upon the subscriber identifier and an embedded caller identifier for the user 114. The gateway server 108 places an outbound PSTN telephone call to the telephone number of the user 114 as provided by the caller identifier field of the SMS text message request. In another embodiment, the user 114 may also provide the telephone number in the SMS text message along with the subscriber identifier. For example, the user 114 may want to send the SMS text message from a smartphone or feature phone. The user 114 may then want to have the voice communication with the subscriber A 102 via a landline telephone. Accordingly, the user 114 may send an SMS text with subscriber identifier and the telephone number at which the user 114 wants to have the voice communication to the gateway server 108.

The gateway configuration 100 provides privacy for each subscriber because an endpoint identifier does not have to be provided to other users. For example, the subscriber 102 may provide an e-mail address to the user 114 without having to provide a corresponding telephone number to that other subscriber. The gateway server 108 maintains the associations between the telephone numbers and e-mail addresses.

If the gateway server 108 determines that the subscriber identifier is not a valid subscriber identifier, the gateway server 108 may inform the user 114 that the subscriber identifier is invalid and may not initiate a voice communication between the subscriber 102 and the user 114. The gateway server 108 may inform the user 114 through an SMS text message, automated voice message, or the like, with an error message regarding the invalid subscriber identifier. Alternatively, the gateway server 108 may disregard the SMS text message received from the user 114 and not provide a reply to the user 114 with an error message regarding the invalid subscriber identifier.

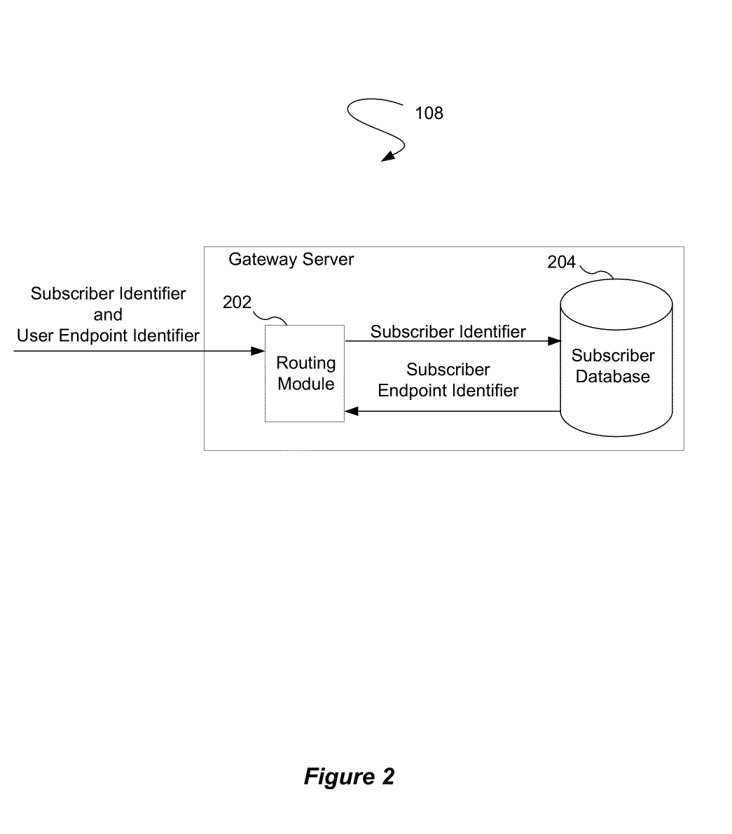

FIG. 2 illustrates the components of the gateway server 108 illustrated in FIG. 1. In one embodiment, the gateway server 108 has a routing module 202 and a subscriber database 204. The routing module may be software that is stored in a memory or a data storage device that is processed by a processor. The routing module 202 establishes a voice communication between the subscriber 102 and the user 114 illustrated in FIG. 1. The routing module 202 utilizes the subscriber identifier received from the user 114 to determine the subscriber endpoint identifier of the subscriber 102. The routing module 202 searches the subscriber database to determine an associated subscriber endpoint identifier for the subscriber identifier. For example, the subscriber 102 may have provided a subscriber identifier, e.g., an e-mail address, and an endpoint subscriber identifier, e.g., a telephone number, during a registration process for the subscription or as a subsequent update. Further, the subscriber 102 may have associated the subscriber identifier with the subscriber endpoint identifier during the registration process for the subscription or as a subsequent update. The gateway server 108 is then able to perform routing to establish a voice communication between the user endpoint identifier, e.g., the telephone number of the user 114, and the subscriber endpoint identifier, e.g., the telephone number of the subscriber 102.

Various types of protocols may be utilized for the communication routes. As an example, Session Initiation Protocol (“SIP”) is an Internet Protocol that may be utilized for VoIP communications. SIP communications involve data being sent and received between different digital endpoints, e.g., SIP addresses.

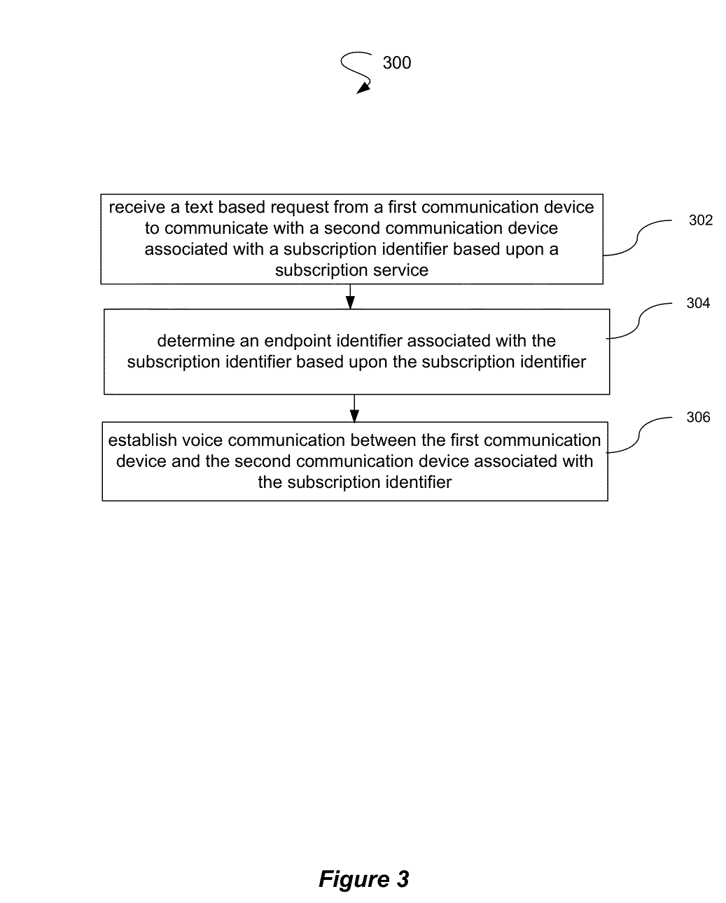

FIG. 3 illustrates a process 300 that may be utilized to establish the voice communication provided for in FIG. 1. At a process block 302, the process 300 receives a text based request from a first communication device to communicate with a second communication device associated with a subscription identifier based upon a subscription service. The text based request includes the subscriber identifier. Further, at a process block 304, the process 300 determines an endpoint identifier associated with the subscription identifier based upon the subscription identifier. In addition, at a process block 306, the process 300 establishes voice communication between the first communication device and the second communication device associated with the subscription identifier.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

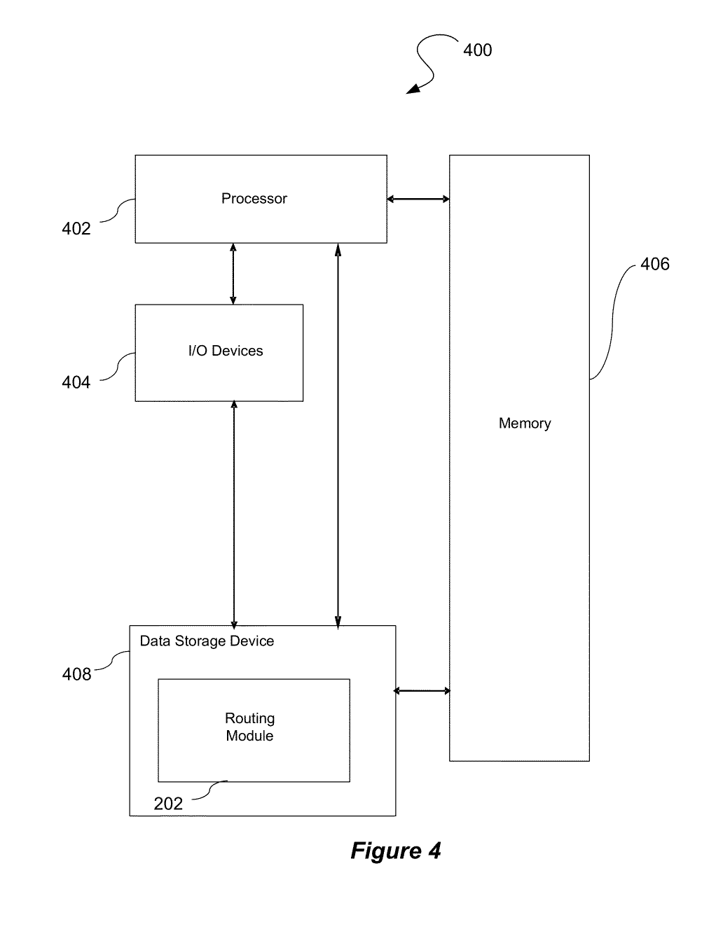

FIG. 4 illustrates a block diagram of a station or system 400 that performs routing to establish voice communication as provided for in FIG. 1. In one embodiment, the station or system 400 is implemented utilizing a general purpose computer or any other hardware equivalents. Thus, the station or system 400 comprises a processor 402, a memory 406, e.g., random access memory (“RAM”) and/or read only memory (ROM), the routing module 202 illustrated in FIG. 2, a data storage device 408 that stores the routing module 202, and various input/output devices 404, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands.

It should be understood that the routing module 202 may be implemented as one or more physical devices that are coupled to the processor 402. For example, the routing module 202 may include a plurality of modules. Alternatively, the routing module 202 may be represented by one or more software applications or a combination of software and hardware where the software is loaded from a storage medium such as a storage device, e.g., a magnetic or optical drive, diskette, or non-volatile memory and operated by the processor 402 in the memory 406 of the computer. As such, the routing module 202 and associated data structures of the present disclosure may be stored on a computer readable medium such as a computer readable storage device, e.g., RAM memory, magnetic or optical drive or diskette and the like.

The station or system 400 may be utilized to implement any of the configurations herein. In one embodiment, the routing module 202 is integrated as part of the processor 402.

Although a subscription service is described, the process, systems, apparatuses, and computer program products described herein may be utilized without any subscription. As an example, the gateway server 108 illustrated in FIG. 1 may be utilized without any subscriptions. A registration process may be utilized. In one embodiment, a registration process is utilized for basic features whereas a subscription service is utilized for enhanced features.

It is understood that the processes, systems, apparatuses, and compute program products described herein may also be applied in other types of processes, systems, apparatuses, and compute program products. Those skilled in the art will appreciate that the various adaptations and modifications of the embodiments of the processes, systems, apparatuses, and compute program products described herein may be configured without departing from the scope and spirit of the present processes and systems. Therefore, it is to be understood that, within the scope of the appended claims, the present processes, systems, apparatuses, and compute program products may be practiced other than as specifically described herein.

I claim:

1. A method comprising:
receiving a text based request from a first communication device to communicate with a second communication device associated with a subscription identifier based upon a subscription service, the text based request including the subscriber identifier;
determining an endpoint identifier associated with the subscription identifier based upon the subscription identifier; and
establishing voice communication between the first communication device and the second communication device associated with the subscription identifier.

2. The method of claim 1, wherein the text based request is in an SMS text message format.

3. The method of claim 1, wherein the first communication device is a feature telephone without VOIP functionality.

4. The method of claim 1, further comprising establishing a telephone connection with the first communication device prior to establishing the voice communication between the first communication device and the second communication device.

5. The method of claim 5, further comprising providing a prompt during the telephone connection.

6. The method of claim 6, wherein the voice communication is established based upon a response from the first communication device to the prompt.

7. The method of claim 1, wherein the subscriber identifier is an e-mail address.

8. The method of claim 1, wherein the subscriber identifier is social networking username.

9. The method of claim 1, wherein the subscriber identifier is a uniform resource locator corresponding to a website address.

10. The method of claim 1, wherein the subscriber identifier is a hashtag topic identifier.

11. The method of claim 1, further comprising determining if the subscriber identifier is valid.

12. The method of claim 1, further comprising determining if a voice mail is activated prior to establishing the voice communication.

13. A computer program product comprising a computer useable medium having a computer readable program, wherein the computer readable program when executed on a computer causes the computer to:
receive a text based request from a first communication device to communicate with a second communication device associated with a subscription identifier based upon a subscription service, the text based request including the subscriber identifier;
determine an endpoint identifier associated with the subscription identifier based upon the subscription identifier; and
establish voice communication between the first communication device and the second communication device associated with the subscription identifier.

14. The computer program product of claim 13, wherein the text based request is in an SMS text message format.

15. The computer program product of claim 13, wherein the first communication device is a feature telephone without VOIP functionality.

16. The computer program product of claim 13, wherein the computer is further caused to establish a telephone connection with the first communication device prior to establishing the voice communication between the first communication device and the second communication device.

17. The computer program product of claim 16, wherein the computer is further caused to provide a prompt during the telephone connection.

18. The computer program product of claim 17, wherein the voice communication is established based upon a response from the first communication device to the prompt.

19. The computer program product of claim 13, wherein the subscriber identifier is an e-mail address.

20. The computer program product of claim 13, wherein the subscriber identifier is social networking username.

21. The computer program product of claim 13, wherein the subscriber identifier is a uniform resource locator corresponding to a website address.

22. The computer program product of claim 13, wherein the subscriber identifier is a hashtag topic identifier.

23. The computer program product of claim 13, wherein the computer is further caused to determine if the subscriber identifier is valid.

24. The computer program product of claim 13, wherein the computer is further caused to determine if a voice mail is activated prior to establishing the voice communication.

25. An apparatus comprising:
a computing device that receives a text based request from a first communication device to communicate with a second communication device associated with a subscription identifier based upon a subscription service, determines an endpoint identifier associated with the subscription identifier based upon the subscription identifier, establishes voice communication between the first communication device and the second communication device associated with the subscription identifier, the text based request including the subscriber identifier.

26. The apparatus of claim 25, wherein the text based request is in an SMS text message format.

27. The apparatus of claim 25, wherein the first communication device is a feature telephone without VOIP functionality.

28. The apparatus of claim 25, wherein the computing device establishes a telephone connection with the first communication device prior to establishing the voice communication between the first communication device and the second communication device.

29. The apparatus of claim 25, wherein the computing device provides a prompt during the telephone connection.

30. The apparatus of claim 29, wherein the voice communication is established based upon a response from the first communication device to the prompt.

31. The apparatus of claim 25, wherein the subscriber identifier is an e-mail address.

32. The apparatus of claim 25, wherein the subscriber identifier is social networking username.

33. The apparatus of claim 25, wherein the subscriber identifier is a uniform resource locator corresponding to a website address.

34. The apparatus of claim 25, wherein the subscriber identifier is a hashtag topic identifier.

35. The apparatus of claim 25, further comprising determining if the subscriber identifier is valid.

36. The apparatus of claim 25, further comprising determining if a voice mail is activated prior to establishing the voice communication.
